(19) United States
(12) Patent Application Publication
(10) Pub. No.: US 2009/0026734 A1
(43) Pub. Date: Jan. 29, 2009

(54) COLLAPSIBLE CART

(76) Inventor: EDWARD R. HOLZMAN, Encino, CA (US)

Correspondence Address: TY UNG, 16830 VENTURA BLVD., SUITE 360, ENCINO, CA, 91436, US

(21) Appl. No.: 11/781,730

(22) Filed: Jul. 23, 2007

(51) Int. Cl. B62B 1/12

(52) U.S. Cl. 280/652

(57) ABSTRACT

A cart that can be collapsed into a clamshell case. The cart comprises a collapsible container extending from a top surface of a bottom shell, a handgrip disposed close to the container for steering the cart, and a plurality of wheels for rolling the cart; the wheels attached to the top shell. The cart further comprises a top shell hinged to the bottom shell such that the top shell can be closed over the bottom shell thereby forming the clamshell case; the top shell to close over the bottom shell only when the container is collapsed.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to household carts and more particularly to collapsible household carts, and even more particularly to a cart which can be collapsed into a clamshell case.

Several collapsible carts have been developed in art. For example, U.S. Pat. No. 3,640,547 to Abraham discloses a collapsible shopping cart comprising a collapsible open top basket, a pair of wheels disposed at the back corners of the basket; the wheels for rolling the cart. The shopping cart further comprises a handle bar integral with lateral legs pivotally secured to the sides of the basket and slidably engaging the bottom of the basket. The sides of the basket are formed by wire ribs arranged to flex outwardly at pivot joints at one more sides of the basket.

U.S. Pat. No. 4,138,139 to Berta discloses a collapsible trash container for supporting a disposable plastic bag within which trash is collected. The container comprises first and second pair of scissor type legs. The top ends of each pair supports a ring structure while the bottom ends are attached with wheels. The mouth of a plastic bag is folded over the ring structure and a keeper in the form of a ring with an annular recess is secured over the folded portion of the bag and thereby over the ring structure so as to keep the mouth of the bag in open position. The container is provided with the pivotally interconnected parts for collapsibility.

U.S. Pat. No. 6,955,365 to Robert discloses a collapsible wheeled shopping container comprising an open top container having front and rear portion, a pair of side portion connecting the front and rear portions and a bottom portion. The side portions are foldable such that the front and the rear portions move closer to each other as the side portions are folded simultaneously. The bottom portion of the container is to be hinged at the bottom of either the front or rear portions; the bottom portion being pivotable about the hinge so that bottom portion does not hinder the collapsibility of the container. The container further comprises at least one wheel for rolling the container; the at least one wheel connected to the bottom portion.

All of the art disclosed above deals with carts or trolleys that are collapsible/foldable. The present invention goes one step ahead of the above art by providing a cart which can be collapsed into a clamshell case, which is relatively easier for storage and also enhances the portability. The objects of the present invention will become better understood with reference to the appended Summary, Description, and Claims.

### SUMMARY

The present invention is a cart collapsible into a clamshell case. The cart comprises a downwardly collapsible container extending from a bottom shell, a pair of wheels for rolling the cart; the wheels attached to the top shell. The cart further comprises a extendible/retractable handgrip for steering the cart and a top shell hinged to the bottom shell such that the top shell covers over the bottom shell so as to form the clamshell case. The container needs to be collapsed prior to the closure of the top shell.

### BRIEF DESCRIPTION OF THE FIGURES

FIG. 1 is a side view of the cart in accordance with the present invention.

FIGS. 2 through 5 are the sequential stages in translating the clamshell case into the cart.

FIG. 6 is a plan view of the clamshell case in accordance with the present invention.

FIG. 7 is side view of the clamshell case in accordance with the present invention.

### FIGURES

### Reference Numerals

10 . . . Cart/Clamshell Case
12 . . . Collapsible Container
14 . . . Rim
16 . . . Handgrip
18 . . . Telescopic Rod
20 . . . Wheel
22 . . . Top Shell
24 . . . Bottom Shell
26 . . . Netted Pocket
28 . . . Button
30 . . . Front Wall Section
32 . . . Side Wall Section
34 . . . Zippered Pocket
36 . . . Retractable Eyelet
38 . . . Flap
40 . . . Clip
42 . . . Pad Structure

### DETAILED DESCRIPTION

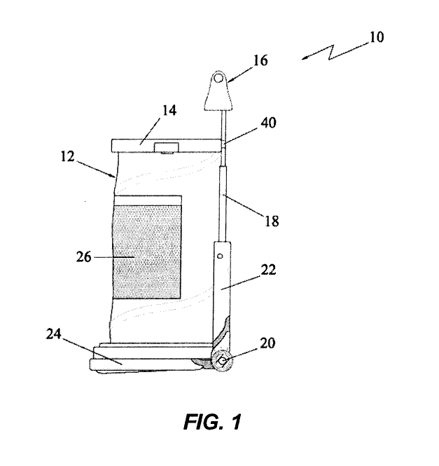

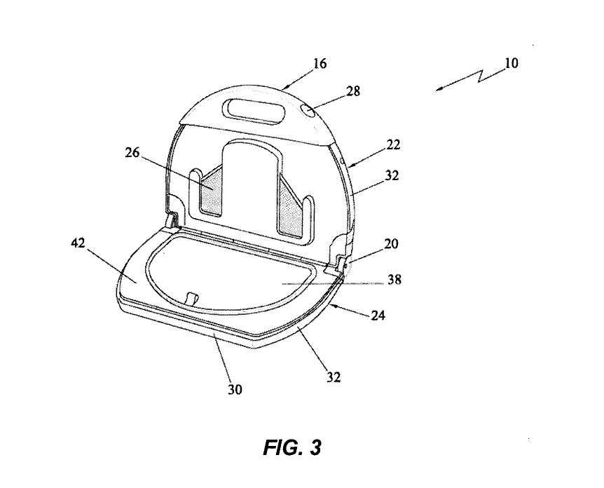

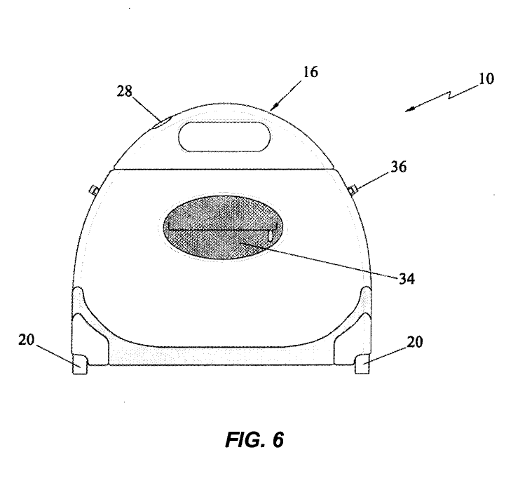

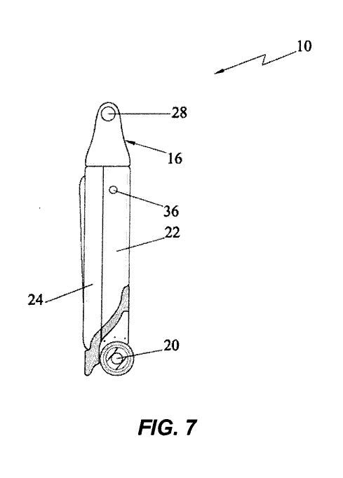

Referring to the drawings, a preferred embodiment of a collapsible cart is illustrated and generally indicated as 10 in FIGS. 1 through 7. The cart 10 of the present invention can be collapsed into a sleek clamshell case 10, which is easy to handle and store.

Referring to FIG. 1, the cart 10 comprises an open top collapsible container 12, top and bottom shells 22 & 24, a handgrip 16 that can be elevated and lowered, and a pair of wheels 20 for rolling the cart 10. The wall of the container 12 is made up of a spring frame, which enables the container 12 to be collapsed as a downward force is exerted thereupon. A tough, flexible fabric is preferably covered over the spring frame so as to conceal it. The top edge of the wall of the container 12 is affixed with a rim 14, which enables a user to compress the container 12 easily. Preferably, the rim 14 is overlaid with a cushioned material so as to enhance the comfort of handling. The top of the rim 14 is hinged with a flap 38 for closing over the container 12. In another embodiment, the flap 38 is to be detachably secured over the rim 14. The container 12 is preferably of a uniform semi-circular cross-section, and retains the same cross-section when collapsed. The rear portion of the wall is chosen to be flat, while the front portion is substantially curved. The container 12 further comprises a netted pocket 26 disposed on the front portion of the wall. The container 12 extends from a top surface of the bottom shell 24.

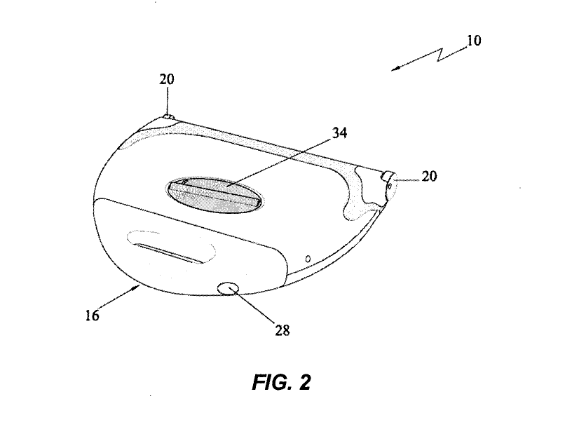

Referring to FIGS. 2, 3, and 6, the top and bottom shells 22 & 24 are substantially similar in shape, each comprising a base panel, which is substantially oblong on plan, and a circumferential wall extending from the periphery thereof. The circumferential wall can be divided into a front wall section 30, a rear wall section, and a pair of sidewall sections 32 connecting the front 30 and rear wall sections. The top edges of the rear wall sections of the top and bottom shells 22 & 24 are hinged together such that the top shell 22 can be pivotally moved between open and closed positions, wherein in the closed position, the top shell 22 closes over the bottom shell 24 so as to form the clamshell case 10. The exterior of the top shell 22 comprises a zippered pocket 34 while the interior of the same comprise two netted pockets 26 for carrying accessories like credit cards, keys, and so on. Further, a pair of retractable eyelets 36 extend from the sidewall sections 32 of the top shell 22; the eyelets 36 for attaching a shoulder strap. However, the eyelets 36 can be pushed into the sidewall sections 32 when not in use. The angle of rotation between the open and closed positions is ranges in between 90 and 100 degrees. The cart 10 is provided with means, which enables the top shell 22 to be locked in both the open and closed positions.

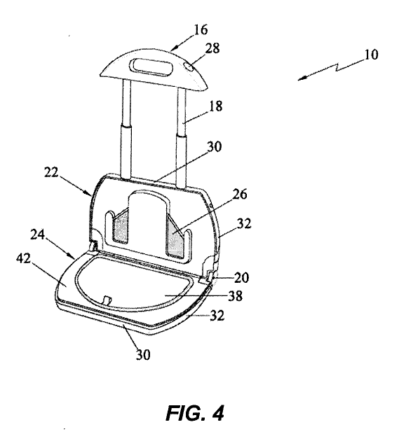

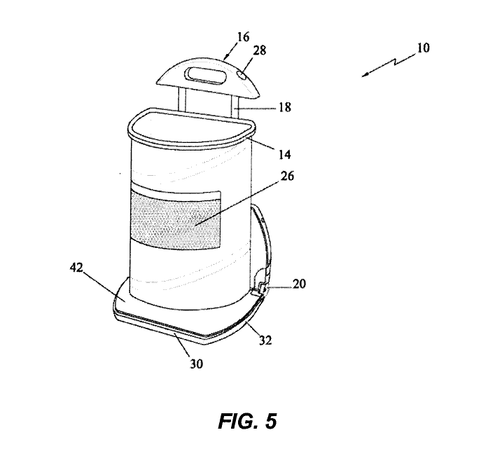

Referring to FIGS. 4 and 5, the container 12 extends, preferably centrally, from the top surface of the base panel of the bottom shell 24 such that the flat rear portion of the wall of the container 12 is substantially parallel to the rear wall section of the bottom shell 24. The bottom shell 24 comprises a pad structure 42 configured for covering the space enclosed between the interior of the circumferential wall and the exterior of the wall of the container 12; the pad structure 42 being integral with the bottom shell 24. More particularly, the pad structure 42 comprises a flat exterior surface, which is disposed at the level of the top edge of circumferential wall; the exterior surface being parallel to the base panel of the bottom shell 24. The flap 38 attached to the rim 14 of the container 12 collapses against the exterior surface of the pad member as the container 12 is collapsed as seen in FIG. 4.

The bottom shell 24 further comprises a latching mechanism for locking the container 12 automatically as it is collapsed. To be more particular, the latching mechanism comprises a pair of spring loaded slide levers that engage/disengage the rim 14 of the container 12 from to the pad structure 42. The container 12 regains its normal functional position by placing one's hands on the container 12 and manually releasing the latching mechanism. It is noteworthy that placing one's hands on the container 12 during its release prevents the container 12 from springing up as soon as latching mechanism is released and thereby avoids any injury resulting thereof.

Referring to FIGS. 4 through 7, the cart 10 further comprises a pair of two-stage telescopic rods 18 extending through and past the front wall section 30 of the top shell 22 such that the rods 18 are substantially perpendicular to the front wall section 30. The ends of the rods 18 are connected by the handgrip 16 so that the handgrip 16 can be lowered or elevated as the rods 18 are retracted or extended respectively. The rods 18 can be retracted or extended by pressing a button 28 disposed on the handgrip 16. The handgrip 16 is preferably disposed above the container 12 in its elevated position and the rods 18 extend parallel to the flat rear portion of the container 12. The handgrip 16 abuts the top shell 22 as the telescopic rods 18 are retracted. The handgrip 16 also abuts and engages the bottom shell 24 as the handgrip 16 is retracted so that the clamshell case 10 can be carried about the handgrip 16. The cart 10 also provides a mechanism for engaging the container 12 to the telescopic rods 18 so as to provide additional support and stability to the container 12. More particularly, the mechanism comprises a pair of clips 40, each engaging the rear flat surface of the container 12 and a telescopic rod 18 as seen in FIG. 1. In another embodiment of the present invention, the telescopic rods 18 comprise a pair of blade rods.

Referring to FIGS. 1, and 5 through 7, the cart 10 further comprises a pair of wheels 20 located at the rear corners of the top shell 24, and a stand extending from the bottom surface of the bottom shell 24 such that the cart 10 stands level on the wheels 20 and the stand. The cart 10 is to be tilted backwards, about 20 degrees, so as to steer it.

Referring to FIGS. 2 through 5, in order to translate the clamshell 10 into the cart 10, the top shell 22 is to be unlocked and rotated to the open position, and the handgrip 16 is elevated. Further, the locking mechanism, which locks the collapsed container 12, is released, so that the container 12 automatically regains its functional position. Finally, the container 12 and the handle are secured. The above process is to be reversed in order to collapse the cart into the clamshell case.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A cart collapsible into a clamshell case, the cart comprising:
(a) a collapsible container extending from a top surface of a bottom shell;
(b) a plurality of wheels for rolling the cart, the wheels attached to the top shell;
(c) a handgrip disposed close to the container, the handgrip for steering the cart; and
(d) a top shell hinged to the bottom shell such that the top shell can be rotated between open and closed positions, wherein in the closed position, the top shell closes over the bottom shell thereby forming the clamshell case; the top shell to close over the bottom shell when the container is collapsed.

2. The cart of claim 1, wherein the container is collapsible by exerting a downward force thereupon.

3. The cart of claim 2 further comprising a latching mechanism for locking the container in its collapsed position.

4. The cart of claim 3, wherein the locking mechanism comprises a plurality of releasable spring-loaded slide levers that keep the container locked or released, the slide levers disposed in the rim of the container.

5. The cart of claim 4, wherein placing ones hands over the collapsed container and manually deactivating the latching mechanism releases the container from its collapsed condition; placing one's hands on the container during its release prevents the container from springing up as soon as latching mechanism is released and thereby avoids any injury resulting thereof.

6. The cart of claim 4, wherein the levers engage the container automatically as the container is compressed.

7. The cart of claim 1 further comprising a mechanism for locking the clamshell case.

8. The cart of claim 1 further comprising a mechanism for locking top shell in its open position.

9. The cart of claim 1, wherein the angle of rotation between the open and closed positions ranges between 90 and 100 degrees.

10. The cart of claim 1, wherein the exterior contour of the top and bottom shells are complimentary.

11. The cart of claim 1, wherein each of the top and bottom shells comprises a base panel, and a circumferential wall extending from the periphery of the base panel, the circumferential wall comprising front and rear wall sections; the container extending from the top surface of the base panel of the bottom shell.

12. The cart of claim 11, wherein the bottom shell further comprises a pad structure configured for covering the space enclosed between the interior surface of the circumferential wall and the exterior surface of the container, the pad structure comprising a flat exterior surface disposed at the level of the top edge of the circumferential wall; the top of the container becomes substantially flush with the exterior surface of the pad structure as the container is collapsed.

13. The cart of claim 11, wherein the front and rear wall sections are substantially perpendicular to the base panel.

14. The cart of claim 11, wherein the base panel is substantially oblong on plan.

15. The cart of claim 11, wherein the circumferential wall further comprises a pair of side panels connecting the front and rear wall sections.

16. The cart of claim 11, wherein the edges of the rear wall sections of the top and bottom shells are hinged together.

17. The cart of claim 16 further comprising a pair of telescopic rods, each extending through and past the front wall section of the top shell, the ends of the rods connected by the handgrip so that the handgrip can be elevated and lowered as the telescopic rods are extended and retracted respectively; the handgrip to be in the elevated and lowered positions as the cart is being steered and collapsed respectively.

18. The cart of claim 17, wherein the telescopic rods are parallel to each other.

19. The cart of claim 17, wherein the handgrip engages the top shell and bottom shell after the cart is collapsed so that clamshell case can be carried by the handgrip.

20. The cart of claim 17 further comprising a button, which when depressed allows the telescopic rods to extend and retract; the button disposed on the handgrip.

21. The cart of claim 17 further comprising a means for securing the container to the extended telescopic rods so as to provide an additional support to the container.

22. The cart of claim 21, wherein the means for securing comprises a plurality of clips attached to the container; the clips configured to engage the telescopic rods when the container is in its functional position and the telescopic rods are extended.

23. The cart of claim 17, wherein the telescopic rods comprise blade rods.

24. The cart of claim 1, wherein the plurality of wheels comprise a pair of wheels extending from the sides of the top shell.

25. The cart of claim 1, wherein the top and bottom shells comprise a skid-protection skin covering the small areas that are exposed to abrasion while the cart is used on stairways.

26. The cart of claim 1, wherein the container comprises a wall comprising a spring frame covered by a fabric on both sides of the wall; the spring frame for enabling the cylinder to collapse when depressed.

27. The cart of claim 26, wherein the container further comprises a rim affixed on top of the container; the rim for enhancing the rigidity of the container and aiding a user in depressing the container.

28. The cart of claim 27 further comprising a flap for covering the container.

29. The cart of claim 28, wherein the flap is hinged to the rim.

30. The cart of claim 28, wherein the flap is to be detachably secured over the rim.

32. The cart of claim 27 further comprising a hood, securely attached to the rim, providing additional volume to the container and securing the contents of the container when the container is in a horizontal position.
